(19) United States
(12) Patent Application Publication
(10) Pub. No.: US 2008/0298876 A1
(43) Pub. Date: Dec. 4, 2008

(54) Multi-Unit Cosmetic Applicator

(75) Inventors: Kristopher Porter, Union Beach, NJ (US); Andrew H. Pechko, Ridgewood, NJ (US); John S. Kurek, Goshen, NY (US)

Correspondence Address: AVON PRODUCTS, INC., AVON PLACE, SUFFERN, NY, 10901, US

(73) Assignee: Avon Products, Inc., New York, NY (US)

(21) Appl. No.: 12/169,933

(22) Filed: Jul. 9, 2008

Related U.S. Application Data
(63) Continuation-in-part of application No. 11/818,027, filed on Jun. 13, 2007.
(60) Provisional application No. 60/900,369, filed on Feb. 8, 2007.

(51) Int. Cl. B43K 27/02; A45D 40/06; B43M 11/06; B43K 29/00; B05C 1/00

(52) U.S. Cl. 401/17; 401/68; 401/183; 401/195

(57) ABSTRACT

A multi-unit cosmetic applicator comprising: a housing body, a first cosmetic unit housed in the housing body, a second cosmetic unit housed in the housing body, an opening in the housing, wherein each cosmetic unit has a means for being independently movable relative to each other from a stored position to an advanced position and back to its stored position. The means may include a ratchet assembly, a squeeze assembly, or a dual twist assembly.

### CROSS-REFERENCE TO RELATED APPLICATION

This application is a continuation-in-part of and claims priority to pending U.S. Ser. No. 11/818,027 filed Jun. 13, 2007, which in turn claims the benefit of U.S. Ser. No. 60/900,369 filed Feb. 8, 2007, each of which hereby are incorporated by reference in its entirety for all purposes.

### BACKGROUND OF THE INVENTION

The present invention relates to applicators for applying a product to the body of the consumer; in particular, to a cosmetic applicator having at least multiple cosmetic units wherein one unit is independently movable with respect to the other units.

### DISCUSSION OF THE PRIOR ART

Cosmetic applicators are designed to deliver a cosmetic agent such as lip gloss, mascara, lip liner, concealer, foundation, eye shadow and eyeliner, etc from a cosmetic unit. The cosmetic unit may be a solid, a liquid reservoir, or the like. Due to ease of design and manufacturing, applicators typically house only one cosmetic unit.

Thus, users must carry a variety of applicators. For example, when applying a hp gloss, it might be useful to also have a lip liner available. Thus, the user must remember to carry both items. This, of course, requires the number of items to carry and reduces the space needed to carry the items.

A need, therefore, exists for a simpler and easier to use cosmetic applicator that also avoids the known shortcomings of only having one cosmetic unit in a housing.

Even when a user carries all items with them, it may be that the cosmetic agents being used are incompatible. In the example above, the lip gloss may include ingredients that react adversely with the lip liner. The conflict may be relatively minor, liquefaction or smearing of one or the other cosmetic agent, to serious, burning or allergic reactions on the user's skin.

Thus, a further need exists for the delivery of cosmetic agents that are compatible with each other. Since cosmetic agents may have different physical states, typically liquid, solid, or amorphous, a need exists for the cosmetic applicator to deliver such compatible cosmetic agents in their state.

### SUMMARY OF THE INVENTION

The needs are met by the present invention. Therein, a cosmetic applicator for dispensing at least a first and a second cosmetic agent on the skin of a user comprises housing having an inner space, a first cosmetic unit comprising the first cosmetic agent disposed in the housing, a second cosmetic unit comprising the second cosmetic agent disposed in the housing, and a means for advancing the second cosmetic unit relative to the first cosmetic unit from a stored position to an advanced position.

The means for advancement may be a slide assembly, a twist assembly, and/or a push button and spring assembly. The means for advancement may also be a dual twist assembly, a ratchet assembly, and squeeze assembly, and/or combinations of the above.

### BRIEF DESCRIPTION OF THE DRAWINGS

The above and other features and advantages will become more readily apparent from a detailed description taken in conjunction with the following drawings, in which:

FIGS. 1a and 1b are front perspective views of a multi-unit cosmetic applicator in accordance with a first embodiment of the invention.

FIGS. 2a-2c are, respectively, a right-side view of a multi-unit cosmetic applicator in accordance with the first embodiment of the present invention, a front view of a dual cosmetic applicator thereof and a cross-sectional view of a dual cosmetic applicator thereof taken along line B-B of FIG. 2b.

FIGS. 3a and 3b are perspective views of a multi-unit cosmetic applicator in accordance with the second embodiment of the invention.

FIGS. 4a-4c are, respectively, a front view of multi-unit cosmetic applicator of the second embodiment of the present invention in an advanced position, a cross-sectional view of a dual cosmetic applicator thereof taken along line A-A of FIG. 4a, and a see-through view of a dual cosmetic applicator thereof in an advanced position.

FIGS. 5a and 5b are front perspective views of a multi-unit cosmetic applicator in accordance with third embodiment of the invention.

FIGS. 6a-6c are, respectively, a right-side view of multi-unit cosmetic applicator of the third embodiment of the present invention, a front view of a dual cosmetic applicator thereof and a cross-sectional view of a multi-unit cosmetic applicator taken along line A-A of FIG. 6b.

FIGS. 7a and 7b are front perspective views of a multi-unit cosmetic applicator in accordance with a fourth embodiment of the invention.

FIG. 8 is a cross-sectional view of the multi-unit cosmetic applicator thereof.

FIGS. 9a and 9b are top perspective views thereof.

FIGS. 10a and 10b are, respectively, a right-side perspective view and a left-side perspective view, as of a multi-unit cosmetic applicator in accordance with a further embodiment of the invention.

FIGS. 11a and 11b are, respectively, a front perspective view and a top view of multi-unit cosmetic applicator.

FIGS. 12a-12e are, respectively, a right-side view of a multi-unit cosmetic applicator, a side partial see-through view of a multi-unit cosmetic applicator, a top partial see-through view of a multi-unit cosmetic applicator, a cross-sectional view of a dual cosmetic applicator taken along line A-A of FIG. 12a, and a partial see-through view of a detail of area B of FIG. 12a.

FIGS. 13a-13d are, respectively, a see-through front view of a multi-unit cosmetic applicator in a stored position, a cross-sectional view of a multi-unit cosmetic applicator taken along line A-A of FIG. 13a, an interior view of a partially opened a multi-unit cosmetic applicator in a stored position, and an exploded view of a multi-unit cosmetic applicator.

FIG. 14a is a see-through front view of a multi-unit cosmetic applicator in a stored position and

FIG. 14b is a cross-sectional view of a multi-unit cosmetic applicator taken along the cross-sectional line of FIG. 14a.

FIG. 15a-15e are, respectively, a front view of a multi-unit cosmetic applicator in a stored and closed position, a cross-sectional view of a multi-unit cosmetic applicator taken along the cross-sectional line of FIG. 15a, a front view of a multi-unit cosmetic applicator in a stored but open position, a cross-sectional view of a multi-unit cosmetic applicator taken along the cross-sectional line of FIG. 15, and an exploded view of a multi-unit cosmetic applicator.

### DETAILED DESCRIPTION OF THE INVENTION

Herein, “cosmetic agent” is used to denote the cosmetic that is applied to the user, while “cosmetic unit” is used to designate the physical formation that includes the cosmetic agent. For example, the lipstick components that are used to cover and/or enhance the lips of the user are the cosmetic agent, while the molded, typically cylindrical, form of the lipstick transported and used from the applicator is the cosmetic unit. Similarly, the liquid in a reservoir would be the cosmetic agent, while the reservoir is the cosmetic unit. One skilled in the art would understand the above not to be an exhaustive list.

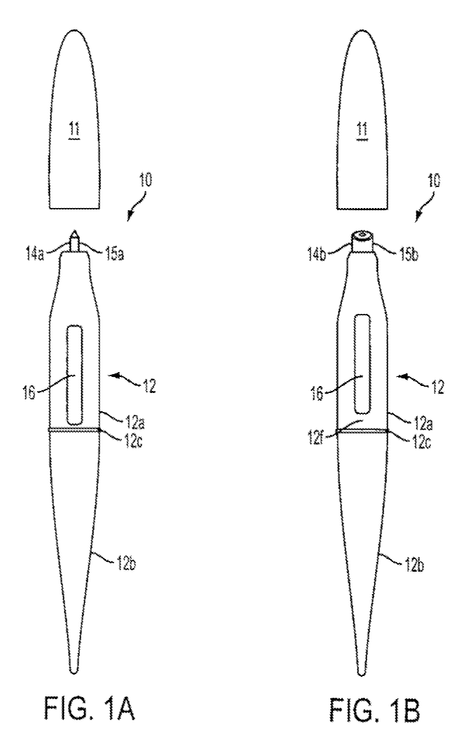

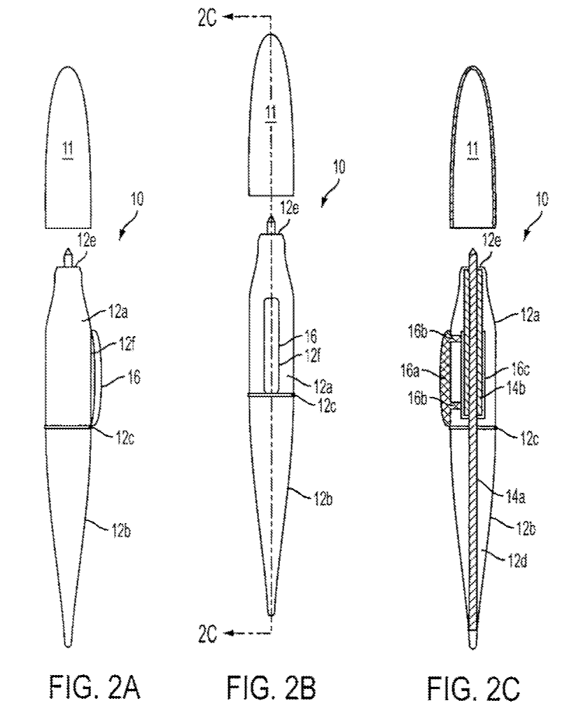

With respect to FIGS. 1 and 2, in a first embodiment of the present invention, a multi-unit cosmetic applicator includes a first cosmetic unit and a second cosmetic unit that is movable with respect to the first cosmetic unit from a stored position to an advanced position via a slide assembly.

Herein, a “stored position” is when the second cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Therein, FIGS. 1a and 1b are front perspective views of a multi-unit cosmetic applicator 10 in accordance with a first embodiment of the invention. FIGS. 2a-2c are, respectively, a right-side view of multi-unit cosmetic applicator 10, a front view of multi-unit cosmetic applicator 10, and a cross-sectional view of multi-unit cosmetic applicator 10 taken along line B-B of FIG. 2b.

Preferably, multi-unit cosmetic applicator 10 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 10 includes a cap 11 and a housing 12. Cap 11 is preferably sized to fit over a substantial portion of an upper housing body 12a that is sealed via a sleeve 12c from a lower housing body 12b.

Lower body 12b comprises an inner space 12d that may be a void space or may be configured as a reservoir for a first cosmetic agent used by a first cosmetic unit 14a. Upper body 12a defines a substantially longitudinal inner space that primarily houses a second cosmetic unit 14b and the means to advance the second cosmetic unit relative to the first.

Housing 12 preferably is designed to have an attractive shape and yet be ergonomically designed to fit in the user's hand. An ergonomic design may include any desired shape that is found to be suitable. As illustrated, lower body 12b may be shaped to taper to a tip while upper housing body 12a has a broader, fuller shape.

Upper housing body 12a includes an opening 12e, suitable for passing both the first cosmetic unit 14a and the second cosmetic unit 14b through such an opening. Opening 12e defines a proximal end of housing 12, while the tip of lower body housing 12b defines a distal end. Upper housing body 12a also includes a substantially longitudinally oriented notch 12f into which a slider assembly 16 is fitted.

First cosmetic unit 14a preferably has a small width to length ratio and reaches well into inner space 12d to wick the first cosmetic agent. For example, cosmetic unit 14a may have a pencil lead shape, one that is substantially cylindrical in cross-section and has a significant length. Therein, cosmetic unit 14a extends the entire length of housing 12 and extends a portion beyond the proximal end of housing 12 to provide a user accessible portion 15a.

In contrast, second cosmetic unit 14b comprises a second cosmetic agent and preferably has greater width to length ratio than the first cosmetic unit 14a. For example, second cosmetic unit 14b has a lipstick shape, one that is substantially cylindrical in cross-section and is relatively shorter than the first cosmetic unit.

Cosmetic unit 14b is disposed about cosmetic unit 14a and, thus, includes longitudinal channel 14c that accommodates the first cosmetic unit 14a. Channel 14c extends longitudinally through the second cosmetic unit 14b and may have any suitable cross-sectional shape that permits the cosmetic unit 14b to move unimpeded relative to the first cosmetic unit. Thus, it should be appreciated that channel 14c includes a peripheral clearance about cosmetic unit 14a.

Using the slider assembly (to be taught hereinafter), the second cosmetic unit is selectably moved relative to the first cosmetic unit from a stored position in housing 12 (FIG. 1a) so that a user accessible portion 15b, of any length, of the second cosmetic unit 14b extends beyond the distal end of the housing (FIG. 1b).

Therein, for example, cosmetic unit 14a may be a lip liner, which has a diameter significantly smaller than the second cosmetic unit 14b, such as a lip gloss. The first cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 10 includes a slider assembly 16. Slider 16 may include a button 16a having a textured surface to provide a tactile response to the user. Slider assembly 16 includes spaced apart arms 16b that connect to a sleeve 16c that retains the second cosmetic unit. Sleeve 16c preferable includes a transverse floor that has an opening of a size suitable for permitting the movement of the second cosmetic unit relative to the first.

When the user pushes slider assembly 16 via button 16a, longitudinally towards the opening and the housing 12d, the second cosmetic unit 14 advances through the opening 12d and a portion 15b is suitably located for a user.

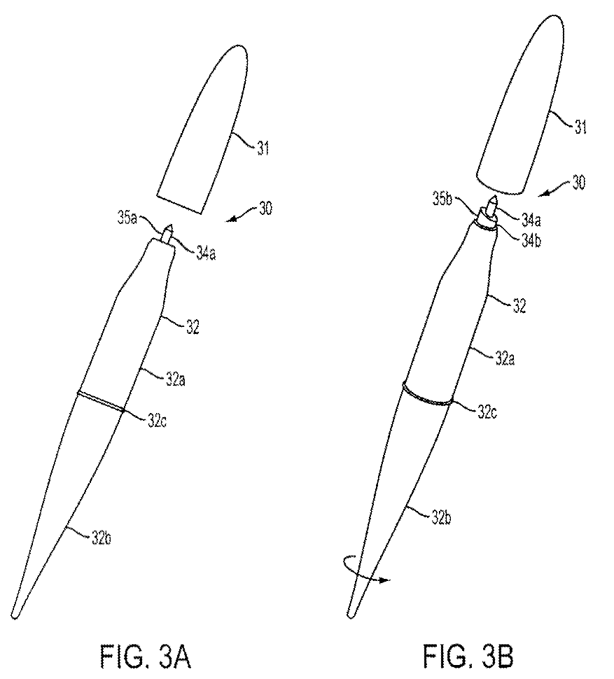

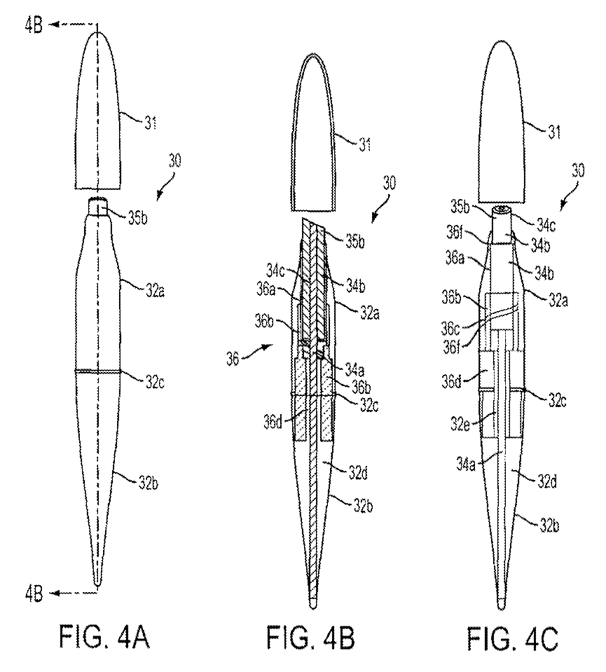

With respect to FIGS. 3 and 4, in a second embodiment of the present invention, a multi-unit cosmetic applicator includes a first housing portion that rotates relative to a second housing portion and advances a second cosmetic agent relative to a first cosmetic agent from a stored position to an advanced position.

Therein, FIGS. 3a and 3b are perspective views of a multi-unit cosmetic applicator 30 in accordance with the second embodiment of the invention. FIGS. 4a-4c are, respectively, a front view of cosmetic applicator 30 in an advanced position, a cross-sectional view of cosmetic applicator 30 taken along line A-A of FIG. 4a, and a see-through view of cosmetic applicator 30 in an advanced position.

Preferably, multi-unit cosmetic applicator 30 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Therein, cosmetic applicator 30 includes a cap 31 and a housing 32. Cap 31 is preferably sized to fit over a substantial portion over an upper housing body 32a that is sealed via a sleeve 32c from a lower body 32b.

Lower housing body 32b comprises an inner space 32d which may be configured as a void space or a reservoir for a first cosmetic agent used by a first cosmetic unit 34a. Upper body 32a defines a substantially longitudinal inner space that primarily houses a second cosmetic unit 34b and the means to advance the second cosmetic unit relative to the first.

Similar to multi-unit cosmetic applicator 10, herein, the first cosmetic unit 34a preferably has a small width to length ratio and reaches well into inner space 32d to wick the first cosmetic agent. For example, cosmetic unit 14a may have a pencil lead shape, one that is substantially cylindrical in cross-section and has a significant length. Therein, cosmetic unit 34a extends the entire length of housing 32 and extends a portion beyond the proximal end of housing 32 to provide a user accessible portion 35a.

In contrast, second cosmetic unit 34b comprises a second cosmetic agent and preferably has greater width to length ratio than the first cosmetic unit 34a. For example, second cosmetic unit 34b has a lipstick shape, one that is substantially cylindrical in cross-section and is relatively shorter than the first cosmetic unit.

Cosmetic unit 34b is disposed about cosmetic unit 34a and, thus, includes longitudinal channel 34c that accommodates the first cosmetic unit 34a. Channel 34c extends longitudinally through the second cosmetic unit 34b and may have any suitable cross-sectional shape that permits the cosmetic unit 34b to move unimpeded relative to the first cosmetic unit. Thus, it should be appreciated that channel 34c includes a peripheral clearance about cosmetic unit 34a. In one embodiment, cosmetic unit 34a is anchored at a distal end of body 32b.

Using the twist assembly (to be taught hereinafter), the second cosmetic unit is selectably moved relative to the first cosmetic unit from a stored position in housing 32 (FIG. 3a) so that a user accessible portion 35b, of any length, of the second cosmetic unit 14b extends beyond the distal end of the housing (FIG. 3b).

Therein, for example, cosmetic unit 34a may be a lip liner, which has a diameter significantly smaller than the second cosmetic unit 34b, such as a lip gloss. The first cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 30 includes a twist assembly 36. Twist assembly 36 includes a sleeve 36a that houses the second cosmetic unit 34b and a plug 36b configured to include a helical guide 36c and cylinder 36d having a channel 36e.

An upper portion of plug 36b fits within the upper housing body 32a while a lower portion comprising approximately half of cylinder 36c is disposed in lower housing body 32b. Therein, body 32b is rotatable with respect to body 32a and rotates with twist assembly 36. Thus, in essence, the lower portion of the cosmetic applicator rotates, while the upper portion of the body is still and the cosmetic unit is advanced longitudinally.

Sleeve 36a further includes spaced-apart pins 36f that travel in guide 36c and is keyed to body 32a in an inner peripheral groove disposed on body 32a. Guide 36c is disposed in the interior surface of the sleeve and is shaped to have a helical surface. By rotating lower housing body 32b, the sleeve twists and moves with respect to the axis of multi-unit applicator 30.

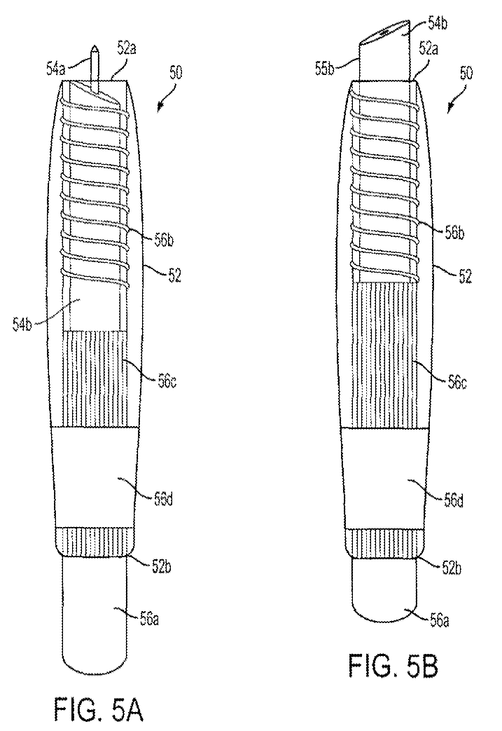

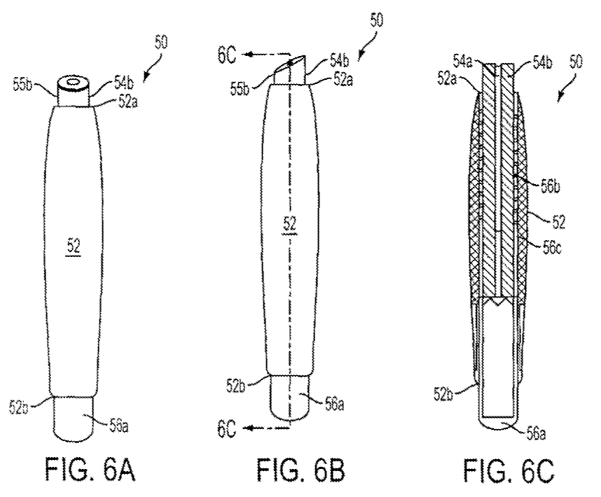

With respect to FIGS. 5 and 6, in a third embodiment of the present invention, a multi-unit cosmetic applicator includes a first cosmetic unit and a second cosmetic unit that is movable with respect to the first cosmetic unit from a stored position to an advanced position via a push button and spring assembly.

Therein, FIGS. 5a and 5b are front perspective views of multi-unit cosmetic applicator 50 in accordance with one embodiment of the invention wherein certain portions of the housing are shown translucent. FIGS. 6a-6c are, respectively, a right-side view of multi-unit cosmetic applicator 50, a front view of multi-unit cosmetic applicator 10, and a cross-sectional view of multi-unit cosmetic applicator 50 taken along line A-A of FIG. 6b.

Preferably, multi-unit cosmetic applicator 50 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 50 may include a cap not shown and a housing 52. The cap if provided is preferably sized to fit over a substantial portion of an upper portion of housing 52.

The housing defines a substantially longitudinal inner space that houses a first cosmetic unit 54a, a second cosmetic unit 54b, a spring that in conjunction with a push button advance the second cosmetic unit relative to the first cosmetic unit.

Housing 52 preferably is designed to have an attractive shape and yet be economically designed to fit in the user's hand. An ergonomic design may include any desired shape that is found to be suitable.

Housing 52 comprises a proximal opening 52a suitable for passing both the first cosmetic unit 54a and the second cosmetic unit 54b through such an opening and a distal opening 52b wherein a push button (to be taught hereinafter) is disposed.

First cosmetic unit 54a preferably has a small width to length ratio and is anchored at distal opening 52b. For example, cosmetic unit 54a may have a pencil lead shape, one that is substantially cylindrical in cross-section and has a significant length. Therein, cosmetic unit 54a extends a portion of the length of housing.

In contrast, second cosmetic unit 54b comprises a second cosmetic agent and preferably has greater width to length ratio than the first cosmetic unit 54a. For example, second cosmetic unit 54b has a lipstick shape, one that is substantially cylindrical in cross-section and is relatively shorter than the first cosmetic unit.

Cosmetic unit 54b is disposed about cosmetic unit 54a and, thus, includes longitudinal channel 54c that accommodates the first cosmetic unit 54a. Channel 54c extends longitudinally through the second cosmetic unit 54b and may have any suitable cross-sectional shape that permits the cosmetic unit 54b to move unimpeded relative to the first cosmetic unit. Thus, it should be appreciated that channel 54c includes a peripheral clearance about cosmetic unit 54a.

Using the push button and spring (to be taught hereinafter), the second cosmetic unit is selectably moved relative to the first cosmetic unit from a stored position in housing 52 (FIG. 5a) so that a user accessible portion 55b, of any length, of the second cosmetic unit 54b extends beyond the distal end of the housing (FIG. 5b).

Therein, for example, cosmetic unit 54a may be a lip liner, which has a diameter significantly smaller than the second cosmetic unit 54b, such as a lip gloss. The first, cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 50 includes a push button 56a, a spring 56b, and a sleeve 56c. Spring 56b is biased against sleeve 56c. Sleeve 56c is substantially cylindrical and retains a lower portion of second cosmetic unit 54b. Push button 56a is biased against the sleeve at a lower edge of the sleeve or is integral with the sleeve, while spring 56b is biased against the sleeve at an upper edge of the sleeve. Spring 56a is biased at a proximal edge against a peripheral rim of opening 52a. A substantially cylindrical guide 56d is retained in a lower part of housing 52 to limit the travel of the push button by engaging a proximal protrusion of the push button.

When the push button is depressed by the user, the second cosmetic unit moves relative to the first cosmetic unit via push button means as are known for example in a pen.

With regard to the embodiments of FIGS. 1-6, the first cosmetic unit, inner unit, comprises and delivers a liquid cosmetic agent. The liquid cosmetic agent may be, but is not limited, to skin treatment serums, lotions, solutions, sunscreen preparations, self-tanning preparations, color enhancing preparations, shine enhancing preparations, preparations that include film formers to improve wear resistant attributes, perspiration and moisture resistance properties; a rubefacient, cosmetics colorants, optical brighteners, glitter or fluorescent materials as desired for additional visual effects.

To do so, the cosmetic unit may comprise suitable natural and synthetic substrate materials that include, but are not limited, to cotton, flax, silk or polyesters, rayons, acrylics, acetates, triacetates, polyolefins, and lyocells. Such substrate materials can be impregnated with the liquid cosmetic agent for subsequent delivery during use of the first cosmetic unit. Preferred are highly absorbent substrate materials.

In one or more embodiments related to the embodiments of FIGS. 1-6, the first cosmetic unit, inner unit, rather than comprising and delivering a liquid cosmetic agent comprises and delivers a solid, semi-solid, or waxy cosmetic agent. Therein, each of the embodiments comprises a take-up mechanism that maintains a sufficient user accessible portion 15a, 35a, or 55a of the cosmetic unit external to the housing.

Such a take up mechanism may be automatic such as a spring assembly or a manually where the user engages the first cosmetic unit and advances it forward.

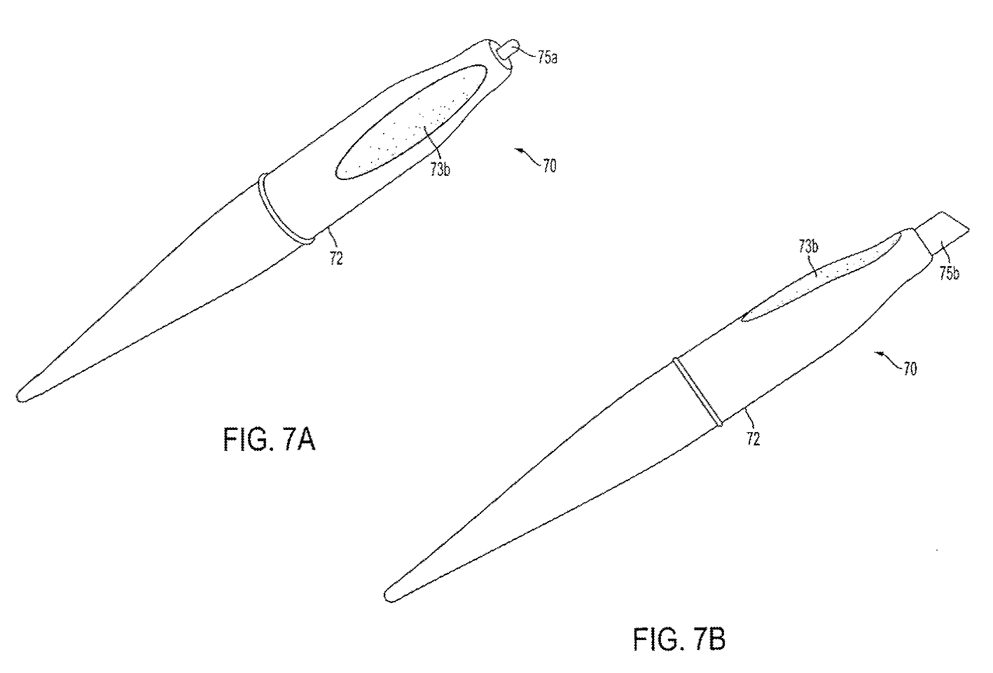

In one or more embodiments related to the embodiments of FIGS. 1-6 or unrelated thereto, an outer cosmetic unit may comprise and deliver a liquid cosmetic agent. Thus, FIGS. 7-9 illustrate a fourth embodiment of a multi-unit cosmetic applicator in accordance with one embodiment of the present invention.

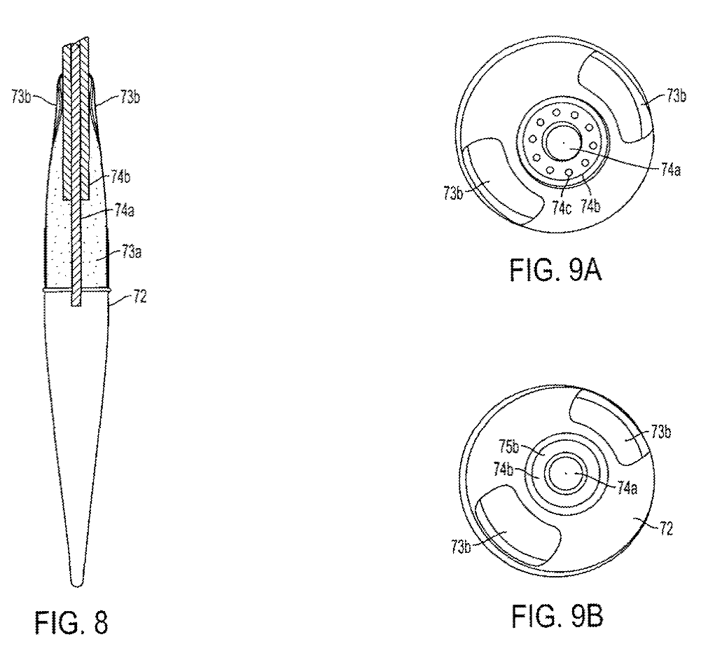

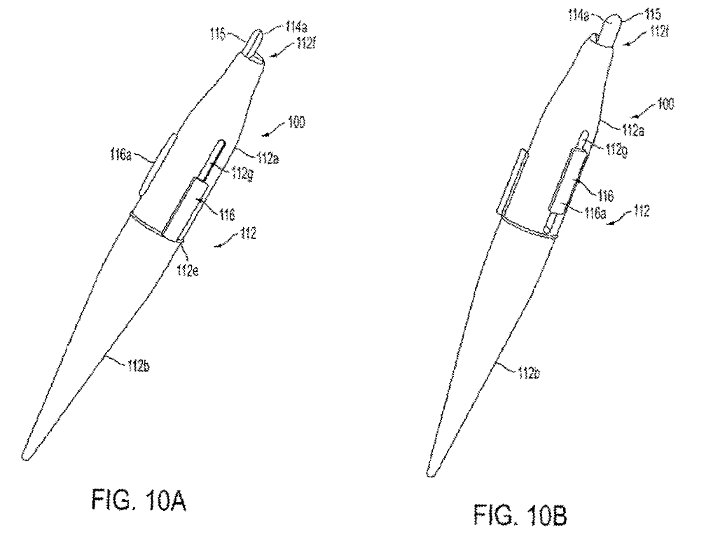

Therein, FIGS. 7a and 7b are front perspective views of multi-unit cosmetic applicator 70 in accordance with one embodiment of the invention. FIG. 8 is a cross-sectional view of the multi-unit cosmetic applicator thereof and FIGS. 9a and 9b are top perspective view thereof.

Multi-unit cosmetic applicator 70 may be constructed substantially in the same manner as taught with respect to any of the foregoing embodiments and having means to advance the second cosmetic unit, herein cosmetic unit 74b, relative to a first cosmetic unit, herein cosmetic unit 74a. The units are sized to substantially permit movement of the second cosmetic unit 74b relative to the first and advance a user accessible portion 75b external to housing 72 to deliver a second cosmetic agent. When the second cosmetic unit 74b is stored, a user accessible portion 75a of cosmetic unit 74a is external to the housing to deliver a first, cosmetic agent.

Housing 72 preferably includes inner space 73a which may be avoid space or may be usable as a reservoir for the second cosmetic agent. Therein, inner space 73a is preferably sealed from any other reservoir. One or more flexible housing portions 73b are disposed in fluid communication with inner space 73a to infuse the second cosmetic unit with the second cosmetic agent.

To permit advantageous delivery of the cosmetic agent at a proximal surface of cosmetic unit 74b, a plurality of apertures 74c (FIG. 9a) as opposed to a smooth surface (FIG. 9b). Each of the cosmetic units may vary in size to allow for controlled application to varying areas and to allow for variable dosage or step treatments.

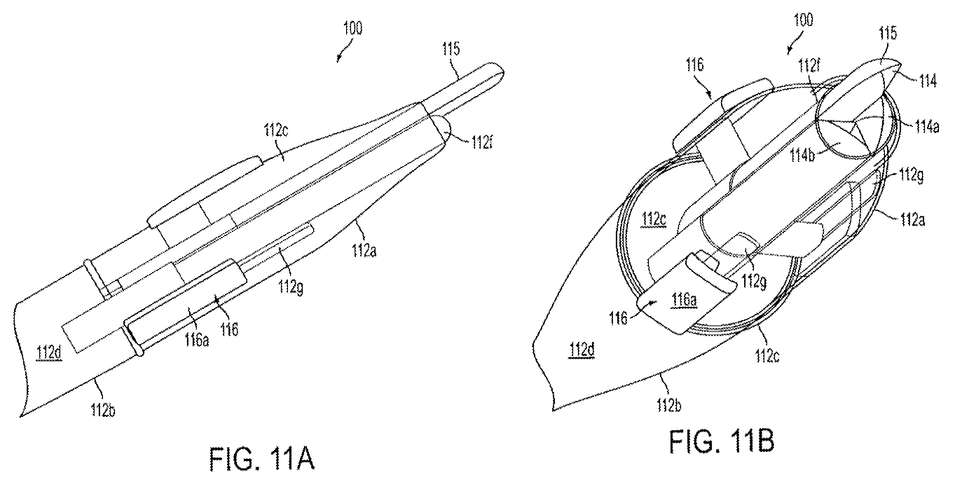

With respect to FIGS. 10, 11, and 12, in a further embodiment of the present invention, a multi-unit cosmetic applicator includes a first, second, and third cosmetic unit that are movable with respect to each other and the housing from a stored position to an advanced position via one or more slide assemblies.

Herein, a “stored position” is when a cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Although, the embodiment of FIGS. 10, 11, and 12 are illustrated with respect to three cosmetic units, limiting the number of cosmetic units and means to advance the cosmetic units to two or increasing the number of cosmetic units and means to advance the cosmetic units to four (4) or greater is also encompassed by the present embodiment.

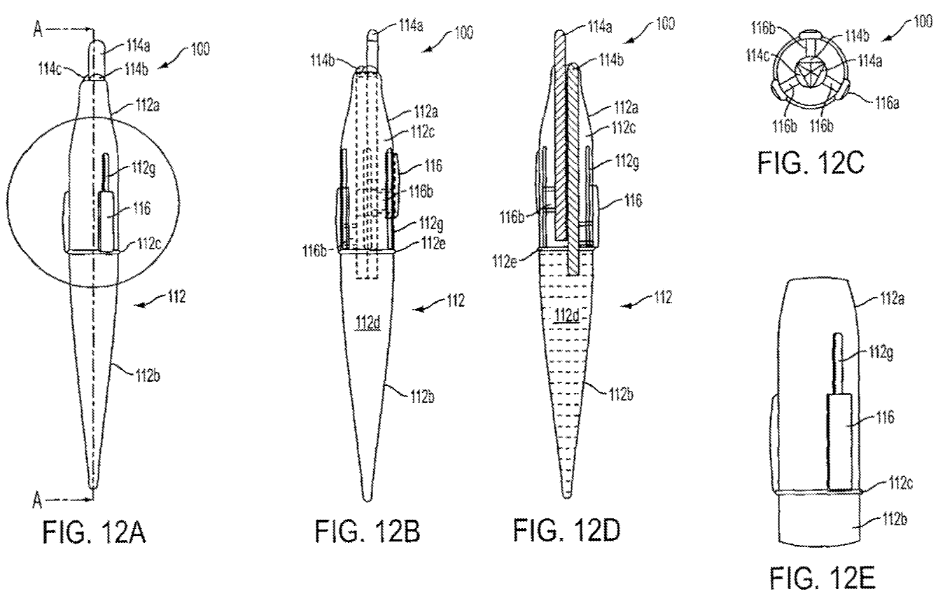

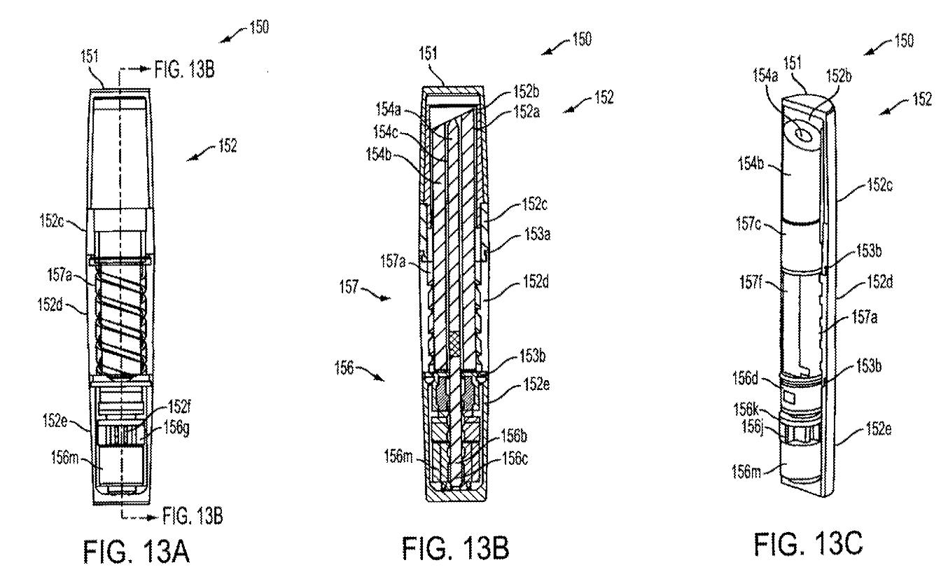

Therein, FIGS. 10a and 10b are, respectively, a right-side perspective view and a left-side perspective view, as of a multi-unit cosmetic applicator 100 in accordance with a further embodiment of the invention. FIGS. 11a and 11b are, respectively, a partial see-through side view and front perspective view of multi-unit cosmetic applicator 100. FIGS. 12a-12e are, respectively, a right-side view of multi-unit cosmetic applicator 100, a side partial see-through view of multi-unit cosmetic applicator 100, a top partial see-through view of multi-unit cosmetic applicator 100, a cross-sectional view of dual cosmetic applicator 100 taken along line A-A of FIG. 12a, and a partial see-through view of a detail of area B of FIG. 12a.

Preferably, multi-unit cosmetic applicator 100 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 100 includes a housing 112 having an upper body 112a and a lower body 112b that are fixedly or removably joined by any known means. Upper body 112a defines a substantially longitudinal inner space 112c for one or more slider assemblies and cosmetic units. Lower body 112b comprises an inner space 112d configured to receive a portion of one or more cosmetic units when in a stored position.

Inner space 112d may be a void space or may also comprise one or more reservoirs that may each house a different cosmetic agent or the same cosmetic agent such as one taught in this application. If the cosmetic agent is fluid one or more reservoirs may be in fluid communication with one or more corresponding cosmetic units.

Housing 112 preferably is designed to have an attractive shape and yet be ergonomically designed to fit in the user's hand. An ergonomic design may include any desired shape that is found to be suitable. As illustrated, lower body 112b may be shaped to taper to a tip while upper housing body 112a has a broader, fuller shape. The upper and lower body may be joined together via a ring portion 112e.

Upper housing body 112a includes an opening 112f, suitable for passing a first cosmetic unit 114a, a second cosmetic unit 114b, and third cosmetic unit 114c through such an opening. Opening 112f defines a proximal end of housing 112, while the tip of lower body housing 112b defines a distal end. Upper housing body 112a also includes substantially one or more longitudinally oriented notches 112g into which a corresponding slider assembly 116 (to be taught hereinafter) are fitted.

Each of three cosmetic units has a substantially longitudinal shape that when in a stored position extends from a proximal end of housing 112 through inner space 112c into inner space 112d at the distal end of the cosmetic unit. In cross-section, each cosmetic unit may have any shape. It may be preferred for each cosmetic unit to represent portion of a larger unit, for example, a segment of a circle or a portion of a triangle. To permit unimpeded independent movement; each cosmetic unit is laterally spaced-apart from another. Thus, it should be appreciated that opening 112f includes a peripheral clearance to permit movement of the cosmetic units.

Using the slider assembly (to be taught hereinafter), each cosmetic unit is selectably moved relative to the other cosmetic units from a stored position in housing 112 so that a user accessible portion 115, of any length, of one or more cosmetic units extends beyond the distal end of the housing. When in an advanced position, each of the cosmetic units extends a portion beyond the proximal end of housing 112 to provide a respective user accessible portion 115.

To move the cosmetic units, multi-unit cosmetic applicator 100 includes one or more slide assembly 116. Each slide assembly 116 may include a button 116a having a textured surface to provide a tactile response to the user. Each slide assembly 116 includes an arm 116b that connects to a sleeve 116c to retain one of the cosmetic units.

When the user pushes slide assembly 116 via button 116a, longitudinally towards the opening and the housing, the respective cosmetic unit advances through the opening 112f and a portion 115 is suitably located for a user.

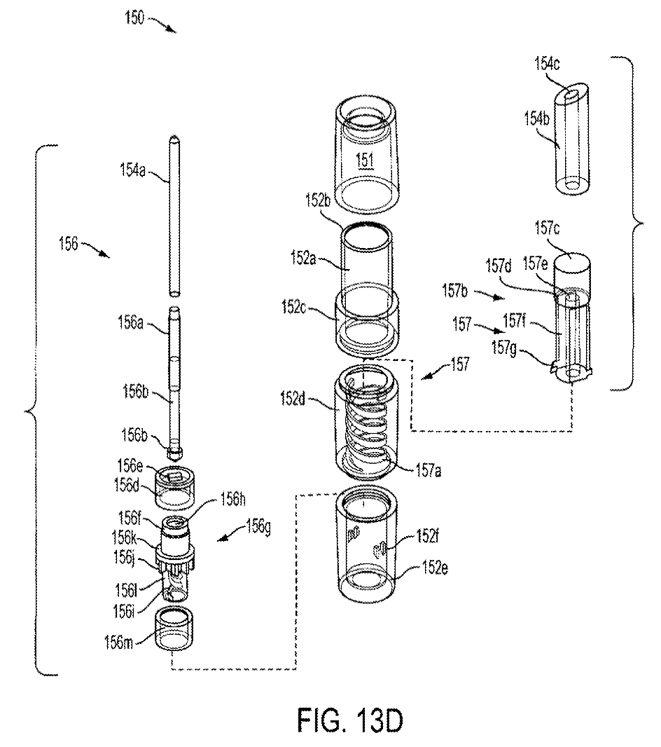

In accordance with one or more embodiments of the present invention. FIGS. 13a-13d are, respectively, a see-through front view of a multi-unit cosmetic applicator 150 in a stored position, a cross-sectional view of a multi-unit cosmetic applicator 150 taken along the cross-sectional line of FIG. 13a, an interior view of a partially opened multi-unit cosmetic applicator 150 in a stored position, and an exploded view of multi-unit cosmetic applicator 150.

Herein, a “stored position” is when a cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Preferably, multi-unit cosmetic applicator 150 is made of plastic, metal, and/or thermoplastic elastomers, rubber, manufactured using blow molding, and assembled by snap-lit assembly. However, any other material, manufacturing, and/or assembly method may be used. Especially desired is to have certain portions of the housing made with anodized plastic materials to give an upscale and refined look.

Multi-unit cosmetic applicator 150 may include a cap 151 and a housing 152. The cap, if provided, is preferably sized to fit over a substantial portion of an upper portion of housing 152.

The housing may comprise an assembly of housing portions and defines a substantially longitudinal inner space that houses a first cosmetic unit 154a, a second cosmetic unit 154b, a dual twist assembly that comprises a first and second twist assembly 156, 157 that are movable independent of each other and selectively advance the first or second cosmetic unit relative to the other cosmetic unit.

For example, first cosmetic unit 154a may be a lip liner, which has a diameter significantly smaller than the second cosmetic unit 154b, such as a lipstick or a lip gloss. However, the first cosmetic units may be a solid, semi-solid or waxy product such as an eye pencil, eye liner, mascara, lipstick, lip liner, lip balm, brow definer, concealer, foundation, blush, etc.

First cosmetic unit 154a preferably has a small width to length ratio. For example, cosmetic unit 154a may have a pencil lead shape, one that is substantially cylindrical in cross-section and has a significant length. Therein, cosmetic unit 154a extends a portion of the length of housing.

In contrast, second cosmetic unit 154b comprises a second cosmetic agent and preferably has greater width to length ratio than the first cosmetic unit 154a. For example, second cosmetic unit 154b has a lipstick shape, one that is substantially cylindrical in cross-section and is relatively shorter than the first cosmetic unit.

Cosmetic unit 154b is disposed about cosmetic unit 154a and, thus, includes longitudinal channel 154c that accommodates the first cosmetic unit 154a. Channel 154c extends longitudinally through the second cosmetic unit 154b and may have any suitable cross-sectional shape that permits the cosmetic unit 154b to move unimpeded relative to the first cosmetic unit. Thus, it should be appreciated that channel 154c includes a peripheral clearance about cosmetic unit 154a.

Housing 152 preferably is designed to have an attractive shape and yet be ergonomically designed to fit in the user's hand. An ergonomic design may include any desired shape that is found to be suitable.

Housing 152 preferably is configured to be a have multiple annular sections and comprises a sleeve portion 152a that may be configured as an AG Shell and is preferably visually appealing to a user. The sleeve portion has a proximal opening 152b suitable for passing both the first cosmetic unit 154a and the second cosmetic unit 154b through such an opening and sleeve portion 152a.

Housing 152 further comprises a “stationary” housing portion 152c for grasping by the user while the first and/or second cosmetic units are advanced or retracted; an upper user portion 152d, i.e., second user portion 152d, that is also a portion of the second twist assembly for selectively advancing or retracting the second cosmetic unit 154b relative to the stationary housing portion 152c; and a lower user portion 152e, i.e., first user portion 152e, that is also a portion of the first twist assembly for selectively advancing or retracting the first cosmetic unit 154a relative to the stationary housing portion 152c. Sleeve portion 152a may be press fit, glued, sonically welded or in some other suitable way attached to stationary housing portion 152c and preferably does not move relative to the stationary housing portion.

Second user portion 152d and stationary housing portion 152c are joined at a circumferential or partially circumferential joint 153a. Preferably, joint 153a is formed by overlapping one reduced circumferential portion of either the second user portion or the stationary housing portion over a circumferential portion of the other, e.g., the other of the second user portion and the stationary housing portion.

Similarly, first user portion 152e and second user portion 152d are joined at a circumferential or partially circumferential joint 153b. Preferably, joint 153b is formed by overlapping one reduced circumferential portion of either the first user portion or the second user portion over a circumferential portion of the other, e.g., the other of the first user portion and the second user portion. By employing a mating notch and depression in each joint, the user portions and/or the stationary housing portion may be quickly assembled, positive seating may be ensured, and resistance to disengagement of the joined parts may be ensured.

User portion 152e preferably comprises a substantially cylindrical body that, defines an inner space capped by a closed end, which when cosmetic applicator 150 assembled, is distal from opening 152b and includes one or more, preferably a pair, of protrusions 152f at a predetermined location.

To move the cosmetic unit 154a, multi-unit cosmetic applicator 150 includes twist assembly 156. Twist assembly 156 comprises a support assembly, which in turn, comprises a sleeve 156a, an extension 156b, and one or more tabs or pins 156c. Sleeve 156a and, preferably, a floor (not shown) laterally and longitudinally support and house the first cosmetic unit 154a and are connected to extension 156b that includes one or more, preferably a pair, of tabs or pins 156c at a distal end of the extension that engage a guide in a cam.

Twist assembly 156 further comprises a cap 156d that configured as a substantially cylindrical body and includes a top surface having a keyhole opening 156e. Opening 156e permits extension 156b and tabs or pins 156c to pass through during assembly and also permits the extension to move along a longitudinal axis of cosmetic applicator 150, but is designed to hold extension 156b without rotational play, e.g., prevents it from rotating relative to the cap to enable the support assembly to move relative to a cam. Thereto, extension 156b may comprise a particular cross-sectional shape that includes features to prevent rotation in the keyhole opening. Cap 156d further includes an open bottom that snaps or is fitted by some other means to proximal portion 156f of a cam 156g.

Twist assembly 156 further comprises cam 156g, which is configured to have a substantially cylindrical body having a channel 156h, e.g., throughbore. The interior wall of the cam, e.g., along the throughbore, includes one or more guides 156i, preferably helical, that extends substantially from a top opening of the cam to a bottom opening of the cam. The guide includes proximal and distal ends.

An exterior surface of the cam includes one or more protrusions 156j that are preferably joined to a stop 156k. Protrusions 156j preferably engage protrusions 152f such that cam 156g is maintained in a fixed rotational position relative to user portion 152e. Preferably, protrusions 152f engage stop 156k such that cam 156g is held at least a specified position spaced from the distal end of user portion 152e. To aid in engaging stop 156k, one or more of protrusions 152f include a substantially planar seat and stop 156k is configured to comprise a substantially planar surface that rests on the seat or seats.

Twist assembly 156 further comprises a cup 156m in which a bottom 156l of cam 156g may be disposed to preferably reduce friction and/or aid in maintaining cam 156g oriented along the centerline of cosmetic applicator 150. e.g., away from inner wall of user portion 156e so that the cam and cosmetic unit 154a are properly aligned.

When twist assembly 156 is assembled, cup 156m is disposed toward the distal end of the inner space of user portion 152e and cam 156g is disposed in user portion 152e and supported by its stop 156k on protrusions 152f. The cam and the user portion will then turn substantially together when turned relative to other user portions. Cap 156d is fitted over cam 156g such that the cap rotates relative to the cam, e.g., user portion 152e. Further, the extension is inserted through the keyhole opening in the cap. Tabs or pins 156c are press fitted or by some other means made to engage the guide in the cam. When user portion 152e is turned relative to stationary housing portion 152e, the extension moves in the helical guide to extend and retract cosmetic unit 154a.

To move the second cosmetic unit, multi-unit cosmetic applicator 150 includes second twist assembly 157 which comprising one or more guides 157a, preferably helical, disposed in the interior wall of user portion 152d and a carrier 157b that is rotatably advanceable or retractable relative the user portion 152d and the stationary housing portion 152c when traveling in the guide.

Carrier 157b includes a sleeve portion 157c that supports the second cosmetic unit 154b laterally and a floor 157d that supports the bottom of second cosmetic unit 154b. Together the sleeve portion and the floor define the inner space that holds the second cosmetic unit. Floor 157d includes an opening 157e that permits passage of sleeve 156a, extension 156b and/or cosmetic unit 154a. To permit unimpeded independent movement; opening 157e includes a peripheral clearance about sleeve 156a, extension 156b and/or cosmetic unit 154a.

Carrier 157b further includes a lower portion 157f that may comprise a wall or be constructed as a solid portion. If constructed as solid portion to aid in guiding sleeve 156a, extension 156b and/or cosmetic unit 154a, opening 157e extends as a channel through the solid portion and preferably includes appropriate peripheral clearance. At a distal end of the carrier, one or more tabs or pins 157g are provided that engage helical guide 157a.

When twist assembly 157 is assembled, tabs or pins 156g are press fitted or by some other means made engage the helical guide in user portion 152d.

In use, the user may retrieve cosmetic applicator 150 from a storage location. Therein, the cosmetic applicator preferably is stored with cap 151 secured and, accordingly, the first and second cosmetic units are disposed in a stored position. The user removes cap 151 and selects either the first or the second cosmetic units to advance. For example, first cosmetic unit 154a is a lip liner; the user may select it first to outline the lips. Thus, the user grasps stationary housing portion 152c and user portion 152e and twists the user portion 152e while holding the stationary housing portion. Twisting housing portion 152e engages twist assembly 156 but not twist assembly 157. In fact, the user portion 152d does not twist or turn with user portion 152e due to construction of joint 153b.

Twisting housing portion 152e engages twist assembly 156 via protrusions 152f that engage protrusions 156j such that cam 156g is maintained in a fixed rotational position relative to user portion 152e, e.g., twists with user portion 152e. However, the support assembly, e.g., sleeve 156a, extension 156b, and pins or tabs 156c, moves relative to the cam in guide 156i. The tip of the cosmetic unit advances through opening 152b into a user-accessible position. If the user accidentally continues turning the user portion 152e, pins or tabs 156c reach a proximal end of the guide and the carrier will cease to advance. Once cosmetic unit 154a is in the user accessible position, the user can apply the agent.

The user then may wish to apply the cosmetic agent of second cosmetic unit 154b, for example, a lipstick. However, prior to that, the user preferably retracts first cosmetic unit by turning user portion 152e relative stationary housing portion 152c in the opposite direction when advancing cosmetic unit 154a. Twisting housing portion 152e once again engages twist assembly 156 via protrusions 152f that engage protrusions 156j such that cam 156g is maintained in a fixed rotational position relative to user portion 152e, e.g., twists with user portion 152e. However, the support assembly, e.g., sleeve 156a, extension 156b, and pins or tabs 156c, moves relative to the cam in guide 156i. The tip of the cosmetic unit retracts through opening 152b into a stored position. If the user accidentally continues turning the user portion 152e, pins or tabs 156c reach the distal end of the guide and the carrier will cease to retract. Once cosmetic unit 154a is in the stored position, the user can apply begin advancing the second cosmetic agent.

Thus, the user grasps stationary housing portion 152c and user portion 152d and twists the user portion 152d while holding the stationary housing portion. Twisting housing portion 152d engages twist assembly 157 but not twist assembly 156. In fact, the user portion 152e does not twist, or turn with user portion 152d due to construction of joint 153b.

Twisting housing portion 152d engages twist assembly 157 via pins or tabs 157f of carrier 157b. The carrier 157b moves relative to the user portion 152d. The tip of cosmetic unit 154b advances through opening 152b into a user-accessible position. If the user accidentally continues turning the user portion 152d, pins or tabs 157f reach a proximal end of the guide and the carrier will cease to advance. Once cosmetic unit 154b is in the user accessible position, the user can apply the agent.

The user then may wish to store cosmetic applicator. In preparation, the user preferably retracts the second cosmetic unit by turning user portion 152d relative stationary housing portion 152c in the opposite direction when advancing cosmetic unit 154b. Twisting housing portion 152d once again engages twist assembly 157 via protrusions 157 and the carrier moves relative to housing portion 152d. The tip of the cosmetic unit retracts through opening 152b into a stored position. If the user accidentally continues turning the user portion 152d, pins or tabs 157f reach the distal end of the guide and the carrier will cease to retract. Once cosmetic unit 154b is in the stored position, the user can close the cosmetic applicator by securing cap 151.

It should be appreciated that the second cosmetic unit may be utilized prior to utilizing the first cosmetic unit and that the cosmetic units may retracted and advanced without a particular requirement to advance one and then retract it prior to advancing or retracting the other. However, utilizing the cosmetic applicator as described above permits a more user-friendly experience.

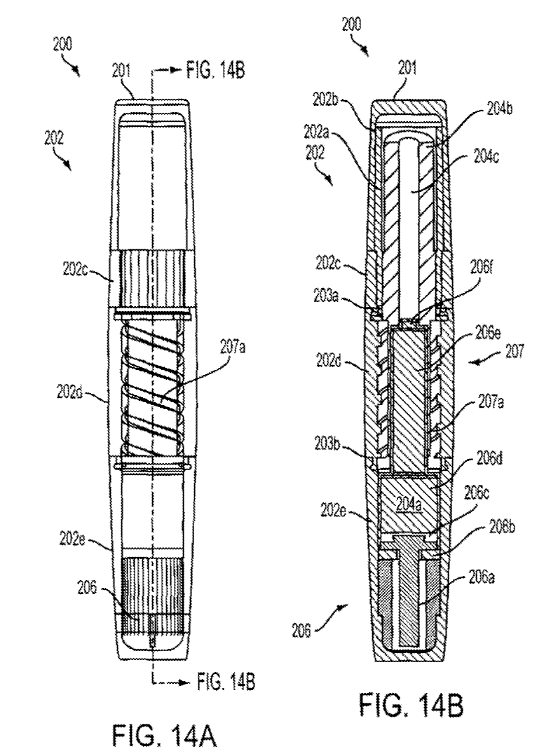

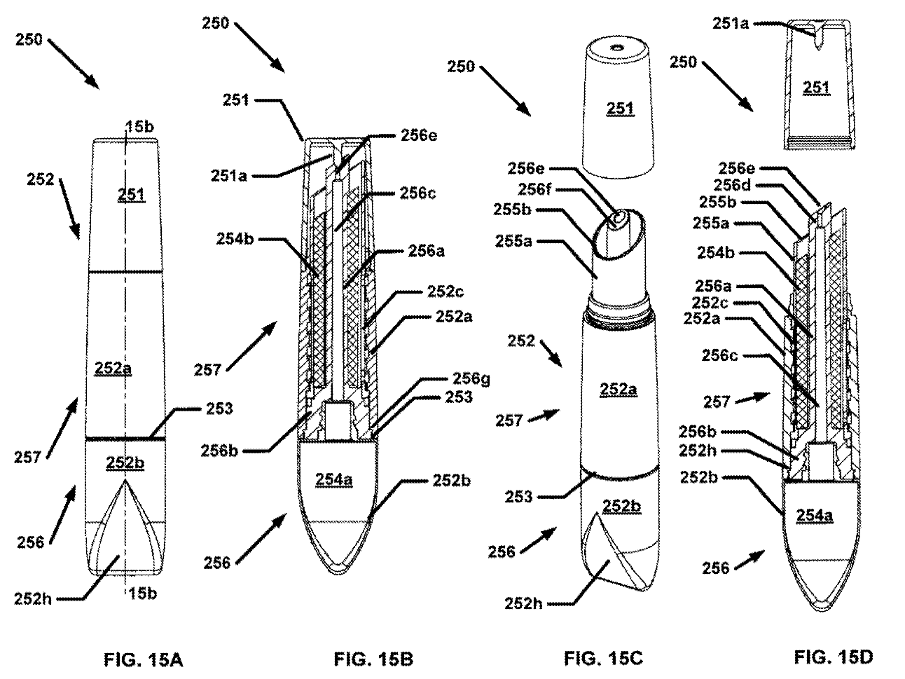

In accordance with one or more embodiments of the present invention. FIG. 14a is a see-through front view of a multi-unit cosmetic applicator 200 in a stored position and FIG. 14b is a cross-sectional view of a multi-unit cosmetic applicator 200 taken along the cross-sectional line of FIG. 14a.

Herein, a “stored position” is when a cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Preferably, multi-unit cosmetic applicator 200 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 200 may include a cap 201 and a housing 202. The cap, if provided, is preferably sized to fit over a substantial portion of an upper portion of housing 202.

The housing may comprise an assembly of housing portions and defines a substantially longitudinal inner space that houses a first cosmetic unit 204a, a second cosmetic unit 204b, a dual advancement assembly that comprises a ratchet assembly 206 and a twist assembly 207 that are independently engageable of each other and to selectively place a fluidized portion of the first cosmetic unit or the second cosmetic unit relative to the other cosmetic unit in a user accessible position and/or to retract one or more cosmetic units.

For example, first cosmetic unit 204a may be a lip gloss or the like, which preferably is a liquid or fluidized material. Second cosmetic unit 204b is preferably a solid or semisolid such as a lipstick or a lip gloss. However, the second cosmetic units may also be a solid, semi-solid or waxy product such as an eye pencil, eye liner, mascara, lipstick, lip liner, lip balm, brow definer, concealer, foundation, blush, etc.

Cosmetic unit 204b preferably includes longitudinal channel 204c that permits fluidized portions of the first cosmetic unit 204a. Channel 204c extends longitudinally through the second cosmetic unit 204b and may have any suitable cross-sectional shape that permits fluidized portions of the cosmetic unit 204a to move unimpeded relative to cosmetic unit 204b.

Housing 202 preferably is designed to have an attractive shape and yet be ergonomically designed to fit in the user's hand. An ergonomic design may include any desired shape that is found to be suitable.

Housing 202 preferably is configured to be a have multiple annular sections and comprises a sleeve portion 202a that may be configured as an AG Shell and is preferably visually appealing to a user. The sleeve portion has a proximal opening 202b suitable for passing both fluidized portions of the first cosmetic unit 204a and the second cosmetic unit 204b through such an opening and a sleeve portion 202a.

Housing 202 further comprises a “stationary” housing portion 202c for grasping by the user while a pressure is applied to the first cosmetic unit to advance a fluidized portion and for grasping while the second cosmetic unit is advanced or retracted, an upper user portion 202d, i.e., second user portion 202d, that is also a portion of the twist assembly for selectively advancing or retracting second cosmetic unit 204b relative to the stationary housing portion 202c, and a lower user portion 202e, i.e., first user portion 202e, that is also a portion of the ratchet assembly for selectively advancing a fluidized portion of the first cosmetic unit 204a relative to the stationary housing portion 202c. Sleeve portion 202a may be press fit, glued, sonically welded or in some other suitable way attached to stationary housing portion 202c and preferably does not move relative to the stationary housing portion.

Second user portion 202d and stationary housing portion 202c are joined at a circumferential or partially circumferential joint 203a. Preferably, joint 203a is formed by overlapping one reduced circumferential portion of either the second user portion or the stationary housing portion over a circumferential portion of the other, e.g., the other of the second user portion and the stationary housing portion.

Similarly, first user portion 202e and second user portion 202d are joined at a circumferential or partially circumferential joint 203b. Preferably, joint 203b is formed by overlapping one reduced circumferential portion of either the first user portion or the second user portion over a circumferential portion of the other, e.g., the other of the first user portion and the second user portion. By employing a mating notch and depression in each joint, the user portions and/or the stationary housing portion may be quickly assembled, positive seating may be ensured, and resistance, to disengagement of the joined parts may be ensured.

User portion 202e preferably comprises a substantially cylindrical body that, defines an inner space capped by a closed end, which when cosmetic applicator 200 assembled, is distal from opening 202b and includes ratchet assembly 206 (shown generally), which comprises a piston 206a held in a retaining structure 206b acting via a piston surface 206c on cosmetic unit 204a held in a reservoir 206d.

Preferably, reservoir 206d is configured to take maximum advantage of available space and may comprise a shape that, includes a changed transverse cross-section. As taught below, a carrier of twist assembly 207 may comprise a structure as shown with respect to carrier 157b. Thus, reservoir 206d may comprise a restricted transverse cross-section in an upper portion 206e to utilize the available. Reservoir 206d preferably includes an opening or more preferably includes a nozzle 206f that directs the fluidized portion forced by the piston into channel 204c.

When user portion 202e is turned, the ratchet assembly is engaged and piston 206a advances front a first position to a second position more proximal to opening 202b and causing a predetermined volume of cosmetic unit 204a to flow through channel 204c toward the tip of cosmetic unit 204b where a user can apply a cosmetic agent of cosmetic unit 204a by itself or in simultaneous combination with the cosmetic agent of cosmetic unit 204b. Unlike twist assembly 207, ratchet assembly 206 does not permit a reversal, e.g., the piston does not recede or retract when the ratchet assembly is turned in a direction that is opposite to the direction that advances the piston from the first to the second position.

To move the second cosmetic unit, multi-unit cosmetic applicator 200 includes twist, assembly 207, which is preferably configured to be substantially identical to twist assembly 157. Twist assembly preferably comprises one or more guides 207a, preferably helical, disposed in the interior wall of user portion 202d and a carrier, substantially similar to carrier 157b that is rotatably advanceable or retractable relative the user portion 202d and the stationary housing portion 202c when traveling in the helical guide.

The carrier preferably includes a sleeve portion that supports the second cosmetic unit 204b laterally and may also include a floor that supports the bottom of second cosmetic unit 204b. Together the sleeve portion and the floor define the inner space that holds the second cosmetic unit. The floor preferably includes an opening that engages opening or nozzle 206f.

The earner further includes a lower portion and at a distal end of the carrier, one or more tabs or pins are provided that engage guide 207a. When twist assembly 207 is assembled, the tabs or pins are press fitted or by some other means made to engage the guide in user portion 202d.

In use, the user may retrieve cosmetic applicator 200 from a storage location. Therein, the cosmetic applicator preferably is stored with cap 201 secured and, accordingly, the first cosmetic unit is in a “stored”, e.g. unused position and the second cosmetic units is disposed in a stored position.

The user removes cap 201 and selects the second cosmetic units to advance. For example, first cosmetic unit 204a may be a lip gloss and may be fluidized by pressure. However, to apply it, the second cosmetic unit, which may be a lipstick or conditioner, must first be advanced.

Thus, the user grasps stationary housing portion 202c and user portion 202d and twists the user portion 202d while holding the stationary housing portion. Twisting housing portion 202d engages twist assembly 207 but not ratchet, assembly 206. In fact, the user portion 202e does not twist or torn with user portion 202d due to construction of joint 203b.

Twisting housing portion 202d engages twist assembly 207 via pins or tabs of the carrier. The carrier moves relative to the user portion 202d. The tip of cosmetic unit 204b advances through opening 202b into a user-accessible position, if the user accidentally continues turning the user portion 202d, pins or tabs reach a proximal end of the guide and the carrier will cease to advance. Once cosmetic unit 204b is in the user accessible position, the user can apply the agent of cosmetic unit 204b and/or the agent of cosmetic unit 204a.

To apply the agent of cosmetic unit 204, the user grasps stationary housing portion 202c and user portion 202e and twists the user portion 202e while holding the stationary housing portion. Twisting housing portion 202e engages ratchet assembly 206 but not twist assembly 207. In fact, the user portion 202d does not twist or turn with user portion 202e due to construction of joint 203b.

Engaging ratchet assembly 206 causes piston 206 to advance in reservoir 206d to force out a predetermined volume of a fluidized portion of cosmetic unit 204a. The fluidized portion leaves the reservoir through opening or nozzle 206f and advances through pressure of additional fluidized material through channel 204c to the tip of cosmetic unit 204b into a user accessible position. The user can then apply the cosmetic agent of cosmetic unit 204a.

The user then may wish to store cosmetic applicator. In preparation, the user preferably retracts the second cosmetic unit by turning user portion 2024 relative to stationary housing portion 202c in the opposite direction when advancing cosmetic unit 204b. Twisting housing portion 2022d once again engages twist assembly 207 via protrusions and the carrier moves relative to housing portion 202d. The tip of the cosmetic unit retracts through opening 202b into a stored position. If the user accidentally continues turning the user portion 202d, pins or tabs of the carrier reach the distal end of the guide and the carrier will cease to retract.

Since the ratchet assembly does not require retraction of cosmetic unit 204a, the user can close the cosmetic applicator by securing cap 151 once cosmetic unit 204b is in the stored position.

As illustrated with respect to the embodiment of cosmetic applicator 200, a rotational ratchet assembly is disclosed. However, it should be appreciated that, a ratchet assembly 206 may be constructed to include a push button assembly that advances a piston in a reservoir that holds a cosmetic unit, such as cosmetic unit 204a. The push-button ratchet assembly may be disposed cooperatively with a twist assembly such as assembly 207, e.g., twist assembly 157.

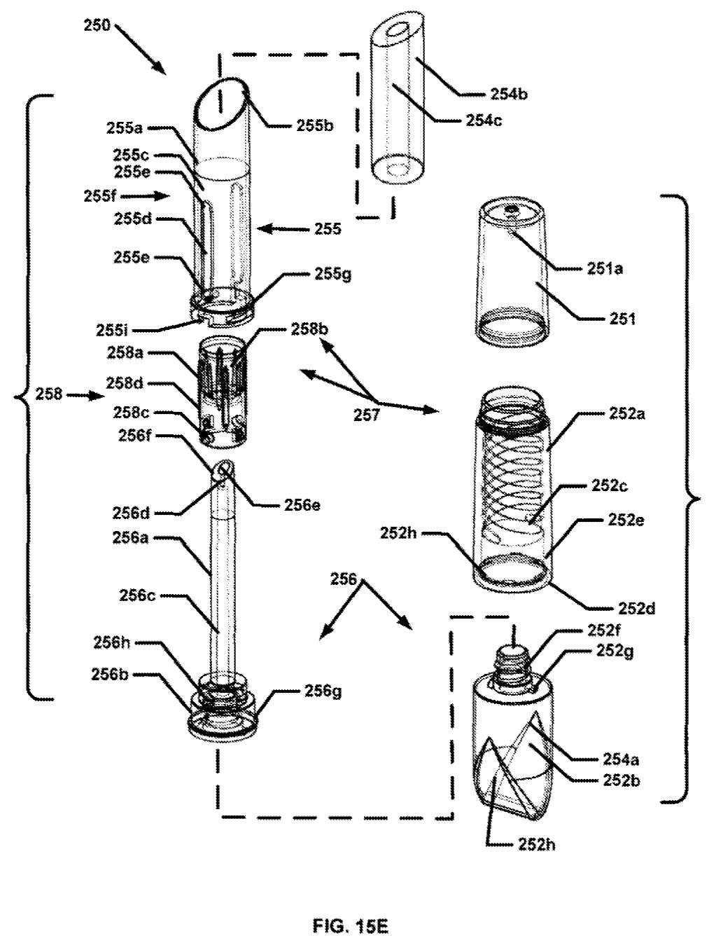

In accordance with one or more embodiments of the present invention. FIG. 15a-15e are, respectively, a front view of a multi-unit cosmetic applicator 250 in a stored and closed position, a cross-sectional view of a multi-unit cosmetic applicator 250 taken along the cross-sectional line of FIG. 15a, a front view of a multi-unit cosmetic applicator 250 in a stored but open position, a cross-sectional view of a multi-unit cosmetic applicator 250 taken along the cross-sectional line of FIG. 15, and an exploded view of multi-unit cosmetic applicator 250.

Herein, a “stored position” is when a cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Preferably, multi-unit cosmetic applicator 250 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 250 may include a cap 251 and a housing 252. The cap, if provided, is preferably sized to fit over a substantial portion of an upper portion of housing 252. Cap 251 includes a tapered plug 251a that fits into a portion of a channel that delivers a portion of the first cosmetic unit.

The housing may comprise an assembly of housing portions and defines a substantially longitudinal inner space that houses a first cosmetic unit 254a, a second cosmetic unit 254b, a dual advancement assembly that comprises a squeeze assembly 256 and a twist assembly 257 that are independently engageable of each other and to selectively place a fluidized portion of the first cosmetic unit or the second cosmetic unit relative to the other cosmetic unit in a user accessible position and/or to retract one or more cosmetic units.

For example, first cosmetic unit 254a may be a lip gloss or the like, which preferably is a liquid or fluidized material. Second cosmetic unit 254b is preferably a solid or semisolid such as a lipstick or a lip gloss. However, the second cosmetic units may also be a solid, semi-solid or waxy product such as an eye pencil, eye liner, mascara, lipstick. Sip liner. Sip balm, brow definer, concealer, foundation, blush, etc.

Cosmetic unit 254b preferably includes longitudinal channel 254c that permits fluidized portions of the first cosmetic unit 254a. Channel 254c extends longitudinally through the second cosmetic unit 254b and may have any suitable cross-sectional shape that permits cosmetic unit 254b to be assembled around a delivery tube of the squeeze assembly.

Housing 252 preferably is designed to have an attractive shape and yet be ergonomically designed to fit in the user's hand. An ergonomic design may include any desired shape that is found to be suitable.

Housing 252 preferably is configured to comprise a first housing portion 252a, e.g., user portion 252a, and a second housing portion 252b, preferably configured as a squeezable tottle tube, which may be snap fit or press fit together during assembly. Housing portion 252a includes one or more guides 252c, preferably helical, in which a carrier is movable to advance or retract cosmetic unit 254b. The guide is preferably spaced from the lower edge 252d by a space 252e to permit a connector to be received in the housing portion.

Squeeze assembly 256 comprises user portion 252b, tube 256a, and connector 256b, which together allow a fluidized portion of cosmetic unit 254a to travel from the user portion 252b to a tip end of tube 256a via at least partially a passageway 256c. User portion 252b acts as a reservoir for cosmetic unit 252a and, preferably, comprises a material that permits the user portion to be squeezed. Thereto, user portion 252b, may have any suitable shape and preferably includes a suitable user-friendly portion 252b that permit the user to have a suitable pressure application area.

User portion 252b includes an attaching mechanism 252f that may be any suitable attaching mechanism to attach to connector, but preferably is a screw thread that mates with a receiving screw head in the connector and includes one or more locking or orienting tabs 252g. The screw mechanism permits easy replacement of user portion 252b when the cosmetic agent 254a has been exhausted by the user or has been rendered unusable or undesirable for any reason.

The passageway may comprise a reduced area 256d before connecting to opening 256e, which may be located on a user friendly angled surface 256f. The reduced area of the passageway serves to maintain pressure and/or prevent undue amounts of air to be able reach the cosmetic unit.

User portion 252a and connector 256b preferably form a circumferential or partially circumferential joint 253. Preferably, joint 253 is formed by having a mated depression and notch that permit rotational movement of either user portion 252a or connector 256b relative to the other. For example, connector 256b may comprise a circumferential or partially circumferential notch 256g and a corresponding depression 252h in user portion 252a. By employing a mating notch and depression in the joint, the user portions may be quickly assembled, positive seating may be ensured, and resistance to disengagement of the joined parts may be ensured.

Twist assembly 257 comprises a sleeve 255 that is sized to jacket a carrier 258, the carrier, and user portion 252a. The sleeve includes an upper sleeve portion 255a that may be configured as an AG Shell and that is preferably visually appealing to a user. Upper sleeve portion 255a includes an opening 255b suitable for passing both the first cosmetic unit 254a and the second cosmetic unit 254b through such an opening.

When a user squeezes user portion 252b, an amount of cosmetic agent is expelled from the user portion and via pressure travels through the connector and passageway to surface 256f, where a user can apply the cosmetic agent.

Sleeve 255 includes a lower sleeve portion 255c in which one or more longitudinal guides 255d are disposed. Each longitudinal guide preferably includes one or more restrictions 255e disposed at each end of guide 255d that narrow the guides and form an initial locking structure 255f.

Sleeve 255 comprises a collar 255g that includes openings 255i that seat onto protrusions 256i on connector 256b such that the sleeve and connector 256b, e.g., user portion 252b, are rotatably joined permitting a carrier that holds the second cosmetic unit to advance or retract relative to the user portion 252b when user portion 252 is twisted.

A carrier 258 is received in sleeve 255 such that the carrier is displace is configured to comprise an elongate, cylindrical structure having an upper portion 258a provided with one or more guides 258b disposed on an internal wall that engage cosmetic unit 254b by friction. One or more pins or tabs 258c are provided on a lower portion 258d and are sufficiently sized to engage guide 255e and guide 252c.

In use, the user may retrieve cosmetic applicator 250 from a storage location and, accordingly, the second cosmetic unit is disposed in a stored position. Therein, the cosmetic applicator preferably is stored with cap 251 secured and plug 251a secured in opening 256e.

For example, cosmetic unit 254b may be a lip stick, the user may select it first to fill in the lips. The user advances retracted cosmetic unit 254b. The user holds user portion 252b and twists user portion 252a causing carrier 258 to move in guides 255e and 252c until they reach the proximal end of guides 255e at which time the carrier pins overcomes the locking force of locking structure 255f. The carrier pins are initially disposed in a locking position in sleeve guide 255d. Thus, the user initially must apply a slightly greater force, which the user can interpret as a confirmation that the internal mechanisms of the cosmetic applicator are working in response to the user. By turning user portion 252a in the reverse, cosmetic unit 254b may be retracted. In the case of the reverse action of retracting cosmetic unit 254b, the locking action can serve as confirmation of secure positioning.

The user may then also apply the first cosmetic unit, by squeezing user portion 252b causing a fluidized portion of the first cosmetic unit to exit via opening 256e.

It should be appreciated that the above disclosure may be adapted by one skilled in the art to arrive at multiple other embodiments and such embodiments are specifically intended to be included in the present invention. For example, a multiunit cosmetic applicator may comprise one or more slider assemblies in combination with one or more twist assemblies and/or ratchet assemblies. Similarly, one or more ratchet, push-button, and squeeze assemblies may be combined in one or more ways in a multi-unit cosmetic applicator.

The following patents and patent publications are hereby incorporated by reference for all purposes:

### US Patent Publication 2005/0100388

U.S. Pat. No. 6,543,458; U.S. Pat. No. 6,497,524.

What is claimed is:

1. A multi-unit cosmetic applicator comprising:
a housing,
a first cosmetic unit housed in the housing,
a second cosmetic unit housed in the housing,
an opening in the housing,
wherein each cosmetic unit has a means for being independently movable relative to each other from a stored position to an advanced position where the respective cosmetic unit is placed in a user-accessible position.

2. The multi-unit cosmetic applicator of claim 1, wherein each means comprises a twist assembly.

3. The multi-unit cosmetic applicator of claim 2, wherein each twist assembly comprises a guide for advancing the respective cosmetic unit relative to the other cosmetic unit.

4. The multi-unit cosmetic applicator of claim 3, wherein each guide comprises a helical shape.

5. The multi-unit cosmetic applicator of claim 1, wherein one means comprises a twist assembly and another means comprises a ratchet assembly.

6. The multi-unit cosmetic applicator of claim 5, wherein the ratchet assembly comprises a piston and a reservoir for storing the first cosmetic unit.

7. The multi-unit cosmetic applicator of claim 6, wherein the piston forces a portion of the first cosmetic unit from the reservoir.

8. The multi-unit cosmetic applicator of claim 7, wherein the second cosmetic unit comprises a channel for delivering the portion of the first cosmetic unit forced from the reservoir into the user-accessible position.

9. The multi-unit cosmetic applicator of claim 1, wherein one means comprises a squeeze assembly and another means comprises a twist assembly.

10. The multi-unit cosmetic applicator of claim 9, wherein the squeeze assembly comprises a tottle tube.

11. The multi-unit cosmetic applicator of claim 9, wherein the squeeze assembly comprises an elongated tube disposed in a channel provided in the cosmetic unit moved by the twist assembly.

12. The multi-unit cosmetic applicator of claim 11, wherein a cap is provided having a plug that seals an opening in the elongated tube.

13. The multi-unit cosmetic applicator of claim 2, wherein each cosmetic unit contains a cosmetic agent, the cosmetic agent of the cosmetic unit comprising one of an eye pencil, an eye liner, a mascara, a lipstick, a lip liner, a lip balm, blush, foundation, a brow definer, and a concealer, a skin treatment a serum, a lotion, a solution, a sunscreen preparation, a self-tanning preparation, a color enhancing preparation.

14. The multi-unit cosmetic applicator of claim 13, wherein the cosmetic agent of the cosmetic unit further comprises a shine enhancing property, an anti-aging property, a film forming property, a preparation that include perspiration resistant properties or a preparation that has moisture enhancing properties.

15. The multi-unit cosmetic applicator of claim 5, wherein the cosmetic unit associated with the ratchet assembly comprises one of a gel and a liquid structure.

16. The multi-unit cosmetic applicator of claim 9, wherein the cosmetic unit associated with the squeeze assembly comprises one of a gel and a liquid structure.

17. A method of using multi-unit cosmetic applicator, the applicator comprising
a housing,
a first cosmetic unit housed in the housing,
a second cosmetic unit housed in the housing,
an opening in the housing,
wherein each cosmetic unit has a first and second means for being independently movable relative to each other from a stored position to an advanced position where the respective cosmetic unit is placed in a user-accessible position;
the method comprising the steps of:
initiating the first means for placing one of the first and second cosmetic unit, in the user accessible position,
initiating the second means for user for placing the other of the first and second cosmetic unit in the user accessible position.

18. The method of using multi-unit cosmetic applicator of claim 17, wherein the step of initiating one of the first and second means comprises twisting a twist assembly.

19. The method of using multi-unit cosmetic applicator of claim 17, wherein the step of initiating one of the first and second means comprises ratcheting a ratchet assembly.

20. The method of using multi-unit cosmetic applicator of claim 17, wherein the step of initiating one of the first and second means comprises squeezing a squeeze assembly.
